(19) United States
(12) Patent Application Publication
(10) Pub. No.: US 2013/0163237 A1
(43) Pub. Date: Jun. 27, 2013

(54) LED RECESSED LIGHT

(71) Applicant: Tzung-Shiun Tsai, Kaohsiung (TW)

(72) Inventor: Tzung-Shiun Tsai, Kaohsiung (TW)

(21) Appl. No.: 13/541,759

(22) Filed: Jul. 4, 2012

(30) Foreign Application Priority Data
Dec. 22, 2011 (TW) 100224236

(51) Int. Cl. F21V 7/20

(52) U.S. Cl. 362/218

(57) ABSTRACT

A recessed light includes LED light strips; parallel casings each including a groove member, a base member, and a cover wherein each LED light strip is disposed in the casing; sets of two electrical ballasts wherein the electrical ballasts of each set are electrically attached to both ends of the LED light strips respectively;

groups of two electrical connectors wherein the electrical connectors of each group are electrically attached to both ends of the LED light strips respectively, and each electrical connector of each group is electrically attached to the electrical ballast of each set; two switching assemblies electrically connected to the electrical connectors respectively, the switching assembly comprising a switch electrically connected to the electrical ballast, and a pull rope extending downward from the switch; and a housing.

### BACKGROUND OF THE INVENTION

1. Field of the Invention

The invention relates to recessed lights and more particularly to a light emitting diode (LED) recessed light with improved characteristics.

2. Description of Related Art

A recessed light is a light fixture that is installed into a hollow opening in a ceiling. When installed it appears to have light shining from a hole in the ceiling, concentrating the light in a downward direction as a broad floodlight or narrow spotlight.

A conventional recessed light fixture comprises a light module including a light source configured to generate all light emitted by the recessed light fixture. The light source can be coupled to a heat sink for dissipating heat from the light source. The heat sink includes a core member from which fins extend. Each fin includes at least one straight and/or curved portion. A housing is coupled to the heat sink and configured to receive a reflector. The reflector has any geometry, such as a bell-shaped geometry including two radii of curvature that join together at an inflection point. An optic coupler is coupled to the housing and configured to cover electrical connections at the substrate and to guide light emitted by the light source. Notwithstanding the prior art disclosure, the invention is neither taught nor rendered obvious thereby.

### SUMMARY OF THE INVENTION

It is therefore one object of the invention to provide a light comprising a plurality of LED light strips; a plurality of parallel casings each comprising an elongated groove member, an elongated base member, and a cover wherein each LED light strip is disposed in the casing; a plurality of sets of two electrical ballasts wherein the electrical ballasts of each set are electrically attached to both ends of the LED light strips respectively; and a plurality of groups of two electrical connectors wherein the electrical connectors of each group are electrically attached to both ends of the LED light strips respectively, and each electrical connector of each group is electrically attached to the electrical ballast of each set.

It is another object of the invention to provide a light comprising a plurality of LED light strips; a plurality of parallel casings each comprising an elongated groove member, an elongated base member, and a cover wherein each LED light strip is disposed in the casing; a plurality of sets of two electrical ballasts wherein the electrical ballasts of each set are electrically attached to both ends of the LED light strips respectively; a plurality of groups of two electrical connectors wherein the electrical connectors of each group are electrically attached to both ends of the LED light strips respectively, and each electrical connector of each group is electrically attached to the electrical ballast of each set; and two switching assemblies electrically connected to the electrical connectors respectively, the switching assembly comprising a switch electrically connected to the electrical ballast, and a pull rope extending downward from the switch wherein a pulling of the pull rope turns on or off the switch.

It is a further object of the invention to provide a light comprising a plurality of LED light strips; a plurality of parallel casings each comprising an elongated groove member, an elongated base member, and a cover wherein each LED light strip is disposed in the casing; a plurality of sets of two electrical ballasts wherein the electrical ballasts of each set are electrically attached to both ends of the LED light strips respectively; a plurality of groups of two electrical connectors wherein the electrical connectors of each group are electrically attached to both ends of the LED light strips respectively, and each electrical connector of each group is electrically attached to the electrical ballast of each set; two switching assemblies electrically connected to the electrical connectors respectively, the switching assembly comprising a switch electrically connected to the electrical ballast, and a pull rope extending downward from the switch wherein a pulling of the pull rope turns on or off the switch; and a housing comprising a rectangular inner frame and a rectangular outer frame secured to the inner frame, the inner frame including at least one set of a rectangular recessed opening and two sockets at both ends of the recessed opening wherein the sockets and the electrical connectors of each group are electrically connected together.

In one aspect of the invention, there is further provided a heat sink disposed in the casing.

In another aspect of the invention, the electrical ballast has a temperature controller.

The above and other objects, features and advantages of the invention will become apparent from the following detailed description taken with the accompanying drawings.

### BRIEF DESCRIPTION OF THE DRAWINGS

FIG. 1 is an exploded view of a light source module of a recessed light according to a first preferred embodiment of the invention;

FIG. 2 is a perspective view of the assembled light source module;

FIG. 3 is a perspective view of a rectangular recessed light having four light source modules of FIG. 2;

FIG. 4 is an exploded perspective view of a light source module of a recessed light according to a second preferred embodiment of the invention;

FIG. 5 is an exploded view of the electrical connector of the light source module of FIG. 4;

FIG. 6 is a perspective view of the assembled light source module of FIG. 4;

FIG. 7 is an exploded view of a recessed light according to a third preferred embodiment of the invention;

FIG. 8 is a perspective view of the assembled recessed light of FIG. 7;

FIG. 9 is a perspective view of a recessed light according to a fourth preferred embodiment of the invention;

FIG. 10 is an exploded view of the light source module of the recessed light of each of the first to fourth preferred embodiments showing a heat sink being mounted therein;

FIG. 11 is a perspective view of the recessed light showing holes of each of the first to fourth preferred embodiments showing another heat sink arrangement; and

FIG. 12 is a block diagram of the temperature controller of the invention.

### DETAILED DESCRIPTION OF THE INVENTION

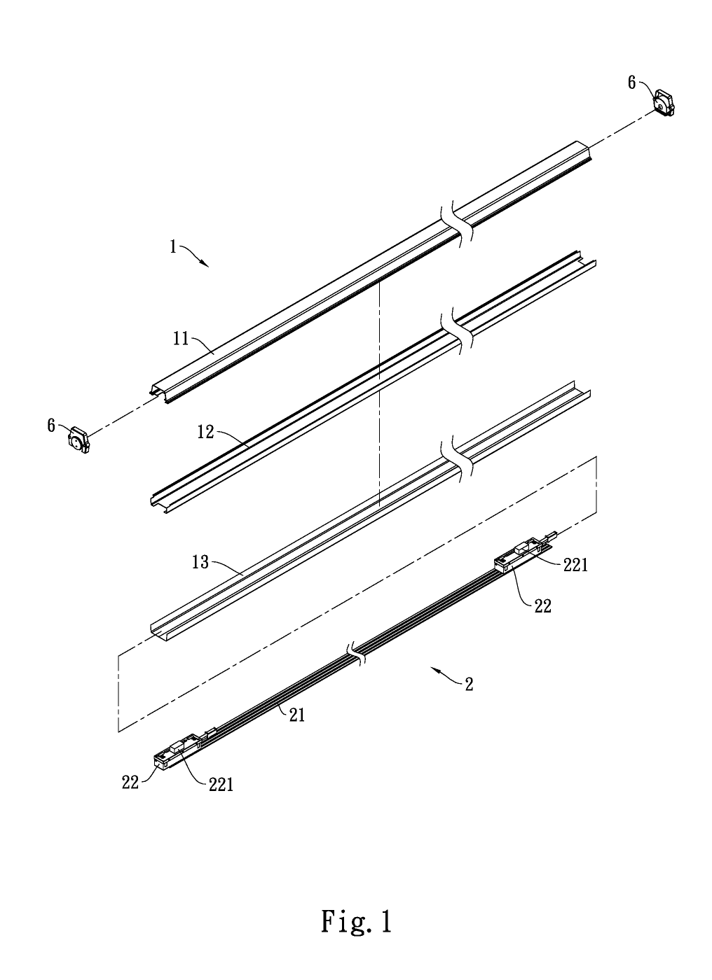

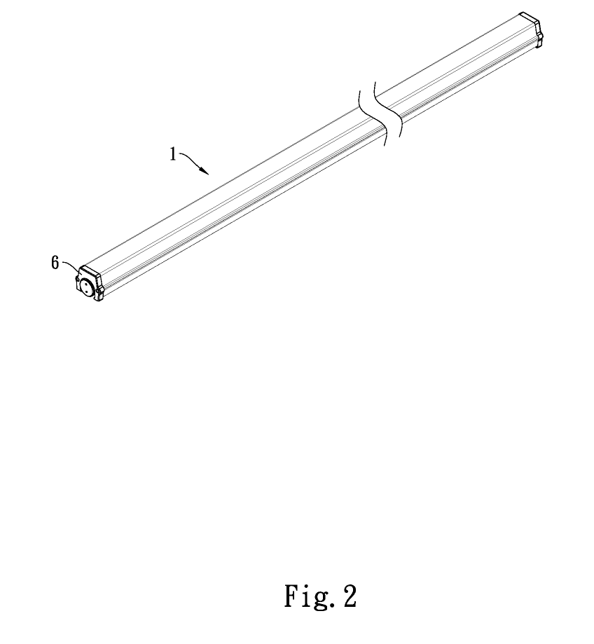

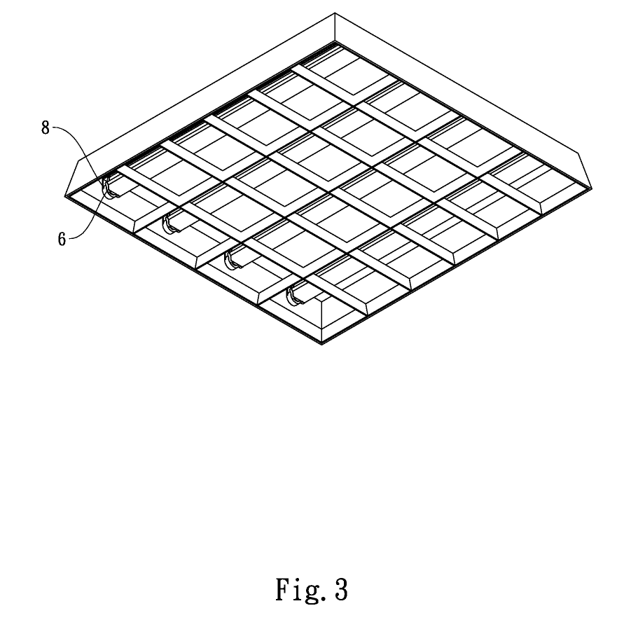

Referring to FIGS. 1 to 3, a recessed light in accordance with a first preferred embodiment of the invention comprises the following components as discussed in detail below. Four light source modules 1 each comprise an elongated groove member 11, an elongated base member 12, a cover 13, a light source assembly 2 including a plurality of parallel light strips (e.g., LEDs) 21, two electrical ballasts 22 attached to both ends of the light strips 21 respectively, each electrical ballast 22 having a temperature controller 221, two electrical connectors 6 each attached to both the electrical ballast 22 and one ends of the light strips 21 and electrically connected thereto, and a rectangular housing 8 for holding the light source modules 1 in spaced, parallel fashion. The light source assembly 2 is disposed in the assembled groove member 11, the base member 12, and the cover 13. Wiring (not shown) is electrically provided between each electrical connector 6 and an external power source.

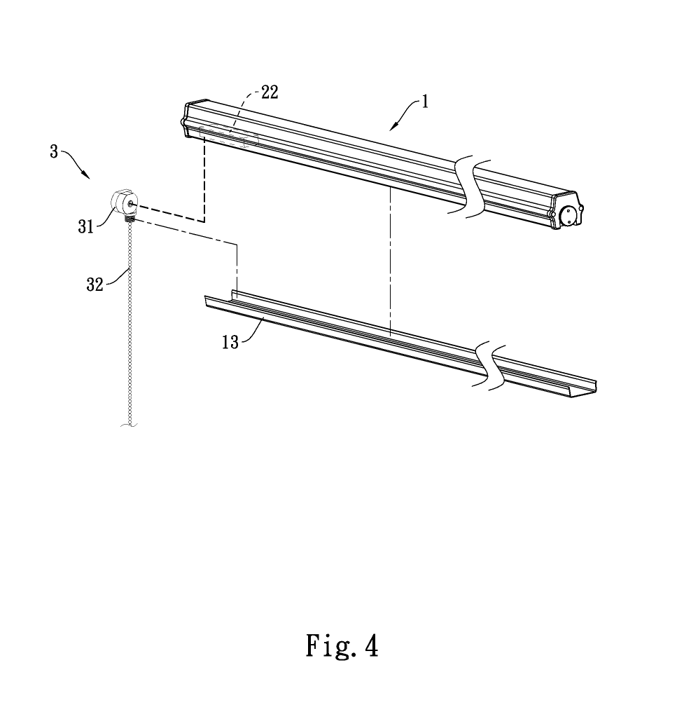

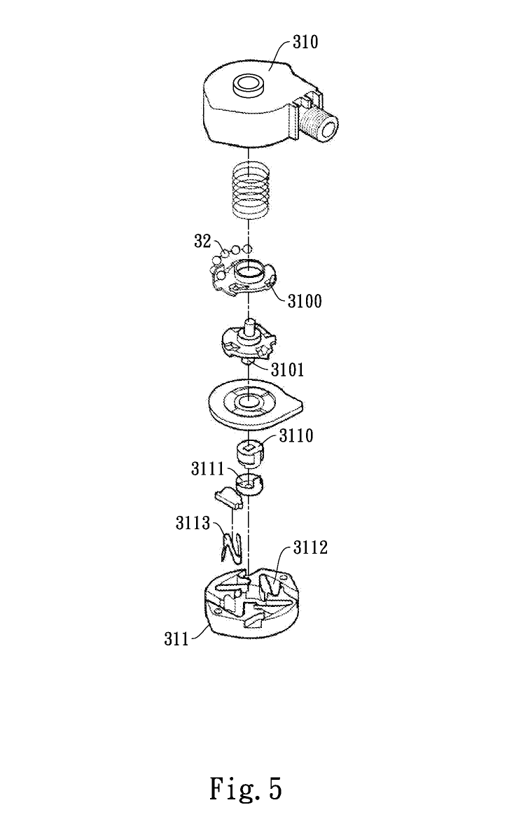

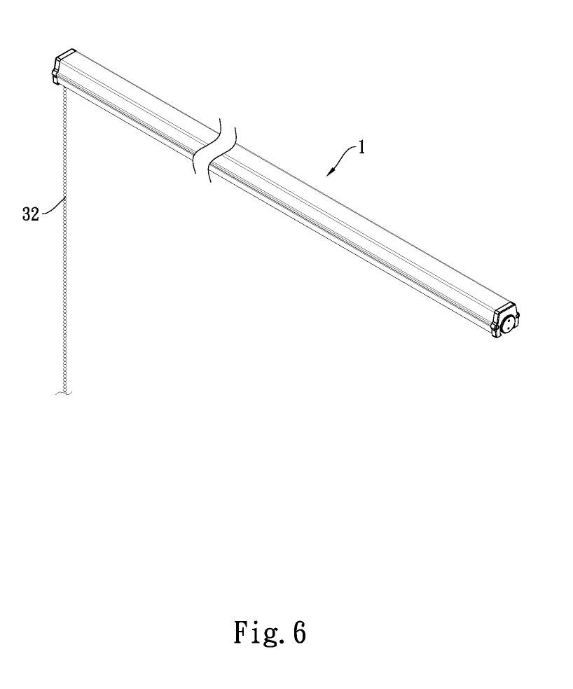

Referring to FIGS. 4 to 6, a recessed light in accordance with a second preferred embodiment of the invention is shown. The characteristics of the second preferred embodiment are substantially the same as that of the first preferred embodiment except the following: Two switching assemblies 3 are further provided to be electrically connected to the electrical connectors. The switching assembly 3 comprises a switch 31 electrically connected to an electrical ballast 22, and a pull rope 32 extending downward from the switch 31 and supported on the cover 13, the pull rope 32 being adapted to pull to turn on or off the switch 31. The switch 31 comprises an upper shell 310 including a rotation member 3100 with one end of the pull rope 32 secured thereto, and a driven member 3101; and a lower shell 311 secured to the upper shell 310 and including a receptacle 3110 for securing to the driven member 3101, a conductive cup 3111 for anchoring the receptacle 3110, a contact 3113 electrically connected to the conductive cup 311 or not, and a well member 3112 for fastening the contact 3113 therein. In a conductive state of the light, the conductive cup 3111, the contact 3113, and the electrical ballast 22 are electrically connected together by rotating the receptacle 3110, the driven member 3101, and the rotation member 3100 by pulling the pull rope 32.

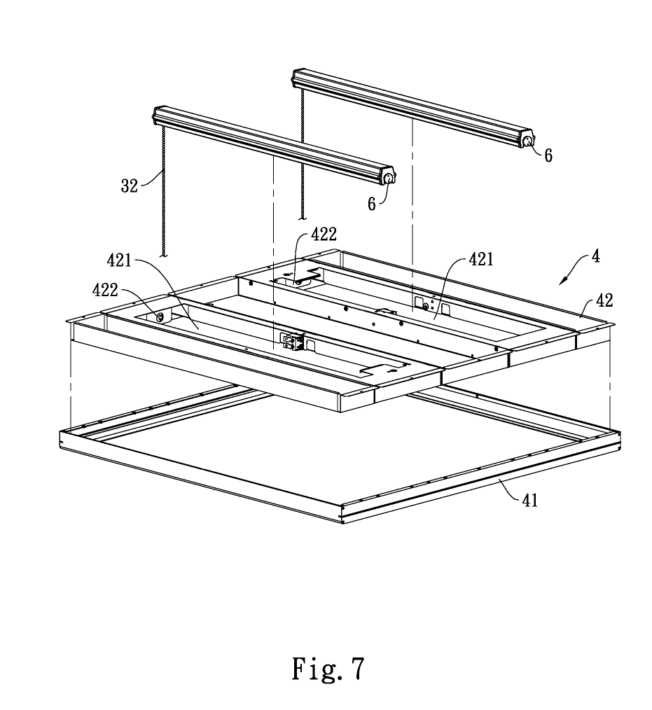

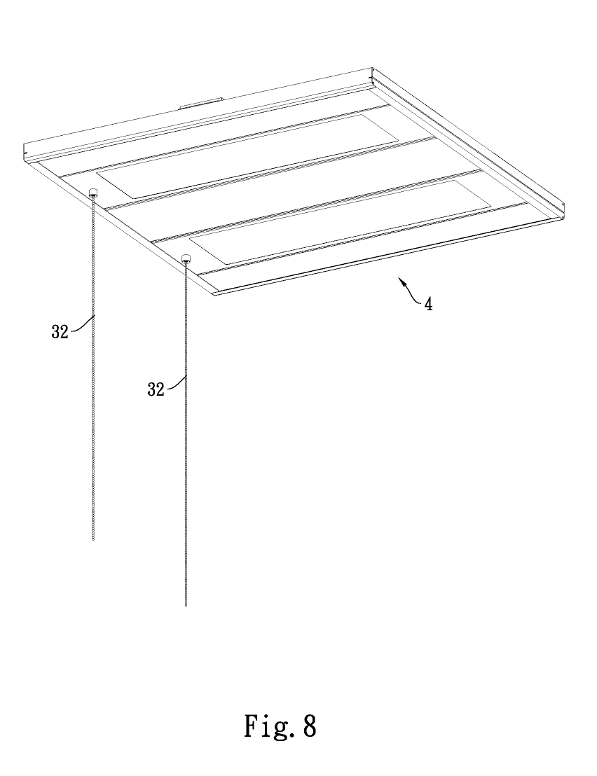

Referring to FIGS. 7 and 8, a recessed light in accordance with a third preferred embodiment of the invention is shown. The characteristics of the third preferred embodiment are substantially the same as that of the second preferred embodiment except the following: One switching assembly 3 is provided to be electrically connected to one electrical connector of each of two light source modules. The single switching assembly includes a pull rope 32. The housing 4 comprises a rectangular inner frame 42 and a rectangular outer frame 41 secured to the inner frame 42. The inner frame 42 includes two sets of a rectangular recessed opening 421 and two sockets 422 at both ends of the recessed opening 421 respectively. In an assembly and operative state, the sockets 422 and the electrical connectors 6 are electrically connected together.

It is envisaged by the invention that the housing 4 can be installed into a hollow opening in a ceiling. Further, either light source module can be turned on or off by pulling the pull rope 32. Thus, it is very convenient in use. Further, energy can be saved.

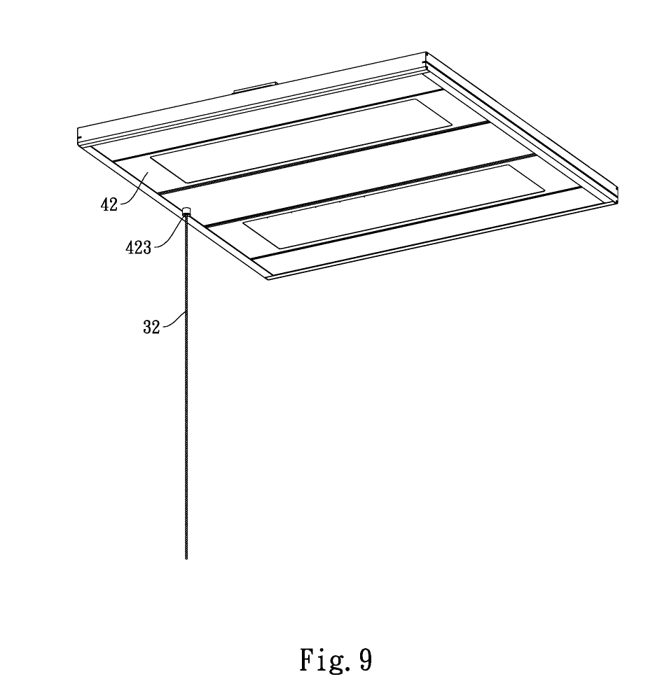

Referring to FIG. 9, a recessed light in accordance with a fourth preferred embodiment of the invention is shown. The characteristics of the fourth preferred embodiment are substantially the same as that of the third preferred embodiment except the following: The two pull ropes 32 are replaced with a single pull rope 32. A bossed hole 423 is provided in the inner frame 42 for allowing the pull rope 32 to pass through. Thus, a pulling of the pull rope 32 can turn on or off both the light source modules.

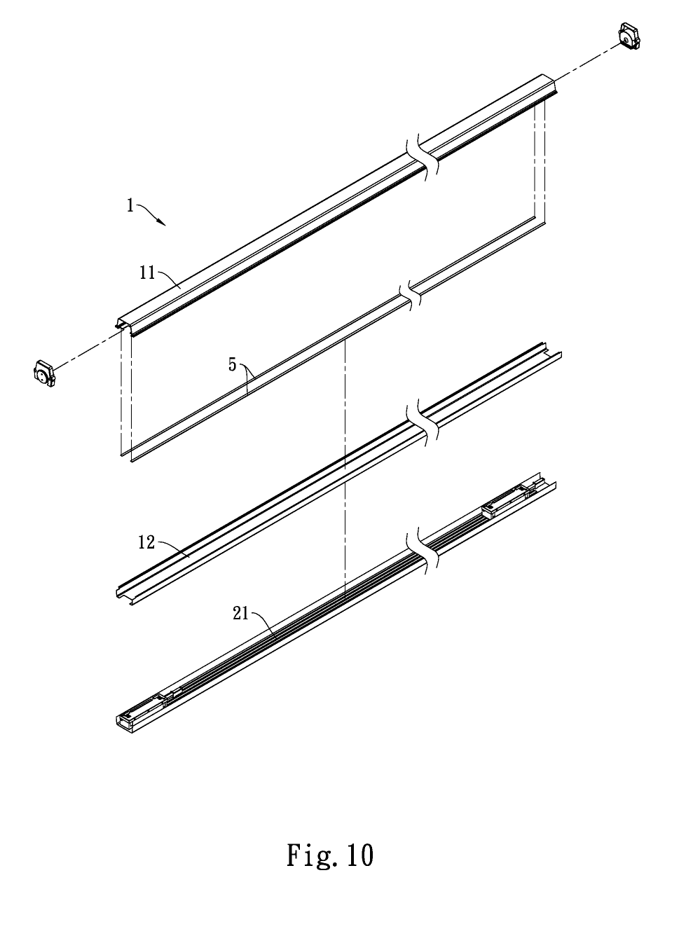

Referring to FIG. 10, two elongated metal strips 5 as a heat sink are mounted in the light source module 1 to contact both the groove member 11 and the base member 12 so that heat generated by the light strips 21 can be dissipated by the metal strips 5.

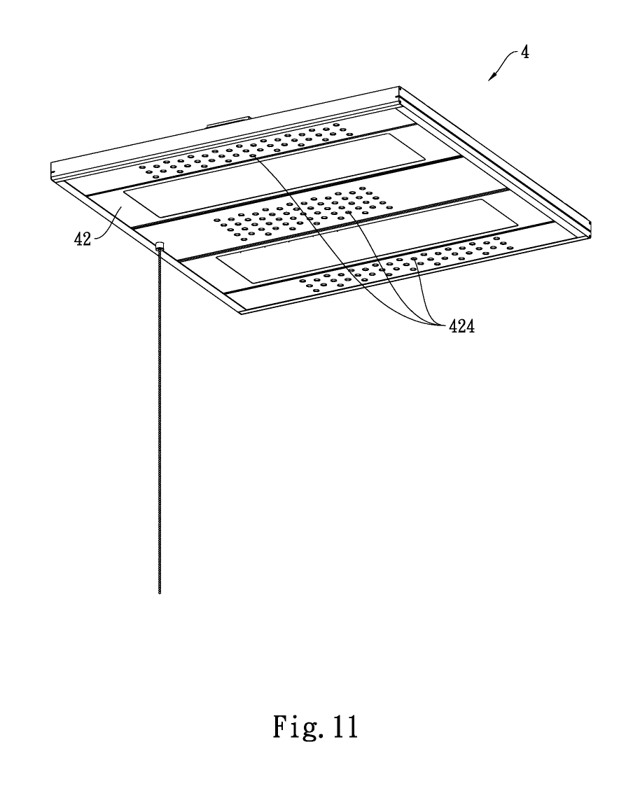

Referring to FIG. 11, three sets of a plurality of holes 424 as a heat sink are provided in the inner frame 42 so that heat generated by the light source modules can be dissipated through the holes 424. Moreover, the provision of the holes 424 can be served as a replacement of conduits for air conditioning. It can save cost.

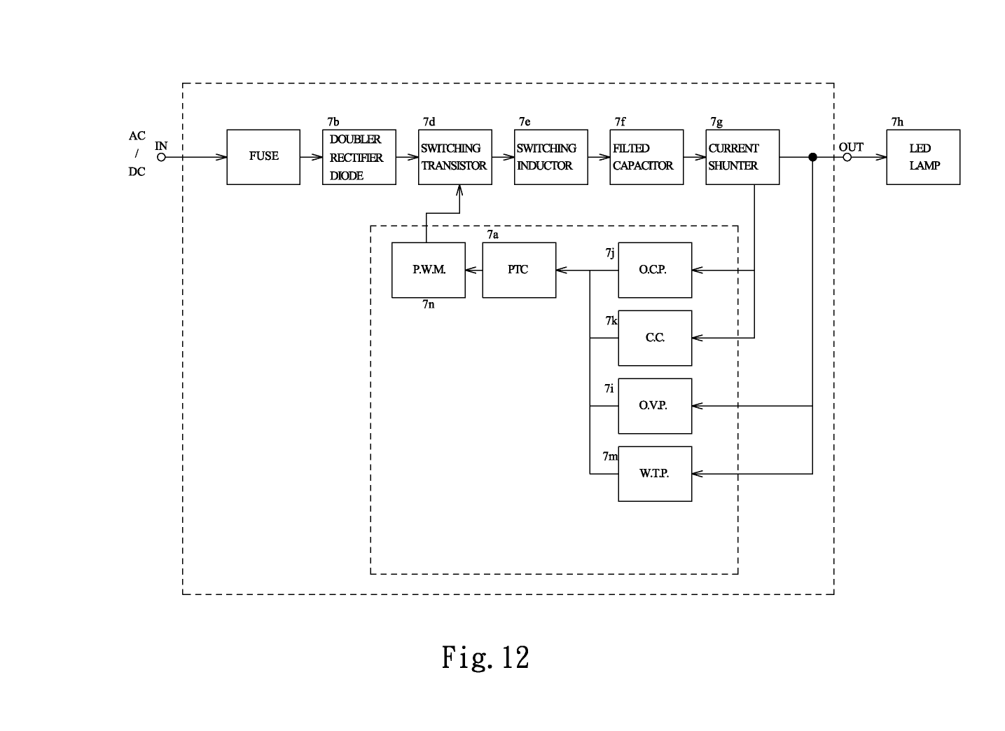

Referring to FIG. 12, the temperature controller 221 of the electrical ballast 22 is shown. The temperature controller 221 is capable of measuring temperature and converting same into a signal which can be read by an electronic instrument. The components of the temperature controller 221 are detailed below.

External AC/DC source is fed to a doubler rectifier diode 7b via a fuse. Next, it is supplied to a switching transformer 7d for lowering the voltage to a desired value. The low voltage is next filtered by a switching inductor 7e. Next, a filter capacitor 7f is employed to further filter the current. Further, the current flowing to a current shunter 7g energizes an LED lamp 7h via an OUT terminal.

A portion of the current feeds back to the switching transformer 7d via parallel over current protection circuit 7j, constant current circuit 7k, over voltage protection circuit 7i and high temperature protection circuit 7m; a temperature control 7a; and a pulse width modulation 7n. Thus, a reliable, regulated power can be supplied to the lamp.

In view of above, the invention has the following advantages:

Its installation is simple. Further, it can replace the typical fluorescent lamp recessed light.

On and off control is made easy by the provision of pull ropes. Further, it is highly adaptable.

Inner and outer frames make the installation easier. Further, it is adapted to various ceilings.

It can save energy and can be custom made.

It is possible of controlling on and off of a plurality of light source modules by the provision of a single pull rope. Further, its operation is convenient.

The provision of the metal strips as a heat sink can dissipate heat from the light source module.

The provision of the holes in the inner frame can also dissipate heat from the light source module.

Further, the holes can replace conduits of air conditioning so as to save cost.

The provision of the temperature controller can supply a reliable, regulated power to the light source module.

While the invention has been described in terms of preferred embodiments, those skilled in the art will recognize that the invention can be practiced with modifications within the spirit and scope of the appended claims.

What is claimed is:

1. A light comprising:
a plurality of LED light strips;
a plurality of parallel casings each comprising an elongated groove member, an elongated base member, and a cover wherein each LED light strip is disposed in the casing;
a plurality of sets of two electrical ballasts wherein the electrical ballasts of each set are electrically attached to both ends of the LED light strips respectively; and
a plurality of groups of two electrical connectors wherein the electrical connectors of each group are electrically attached to both ends of the LED light strips respectively, and each electrical connector of each group is electrically attached to the electrical ballast of each set.

2. The light of claim 1, further comprising a heat sink disposed in the casing.

3. The light of claim 1, wherein the electrical ballast has a temperature controller.

4. A light comprising:
a plurality of LED light strips;
a plurality of parallel casings each comprising an elongated groove member, an elongated base member, and a cover wherein each LED light strip is disposed in the casing;
a plurality of sets of two electrical ballasts wherein the electrical ballasts of each set are electrically attached to both ends of the LED light strips respectively;
a plurality of groups of two electrical connectors wherein the electrical connectors of each group are electrically attached to both ends of the LED light strips respectively, and each electrical connector of each group is electrically attached to the electrical ballast of each set; and
two switching assemblies electrically connected to the electrical connectors respectively, the switching assembly comprising a switch electrically connected to the electrical ballast, and a pull rope extending downward from the switch wherein a pulling of the pull rope turns on or off the switch.

5. The light of claim 4, further comprising a heat sink disposed in the casing.

6. The light of claim 4, wherein the electrical ballast has a temperature controller.

7. A recessed light comprising:
a plurality of LED light strips;
a plurality of parallel casings each comprising an elongated groove member, an elongated base member, and a cover wherein each LED light strip is disposed in the casing;
a plurality of sets of two electrical ballasts wherein the electrical ballasts of each set are electrically attached to both ends of the LED light strips respectively;
a plurality of groups of two electrical connectors wherein the electrical connectors of each group are electrically attached to both ends of the LED light strips respectively, and each electrical connector of each group is electrically attached to the electrical ballast of each set;
two switching assemblies electrically connected to the electrical connectors respectively, the switching assembly comprising a switch electrically connected to the electrical ballast, and a pull rope extending downward from the switch wherein a pulling of the pull rope turns on or off the switch; and
a housing comprising a rectangular inner frame and a rectangular outer frame secured to the inner frame, the inner frame including at least one set of a rectangular recessed opening and two sockets at both ends of the recessed opening wherein the sockets and the electrical connectors of each group are electrically connected together.

8. The recessed light of claim 7, further comprising a heat sink disposed in the casing.

9. The recessed light of claim 7, wherein the electrical ballast has a temperature controller.

10. The recessed light of claim 7, further comprising a bossed hole in the inner frame for allowing each pull rope to pass, and a plurality of openings in the inner frame as a heat sink.
